(19) United States
(12) Patent Application Publication
(10) Pub. No.: US 2016/0369039 A1
(43) Pub. Date: Dec. 22, 2016

(54) PROCESS FOR PRODUCING NATURAL OIL BASED POLY-URETHANE DISPERSION

(71) Applicant: Roidec India Chemical (P) LTD, New Delhi (IN)

(72) Inventors: Puja JAIN, Gurgaon (IN); Sandeep JAIN, Gurgaon (IN)

(21) Appl. No.: 15/255,363

(22) Filed: Sep. 2, 2016

Related U.S. Application Data
(63) Continuation-in-part of application No. 14/001,205, filed on Aug. 23, 2013, now abandoned.

(30) Foreign Application Priority Data
Mar. 1, 2011 (IN) 553/DEL2011

(51) Int. Cl. C08G 18/70; C08G 18/10

(52) U.S. Cl. CPC C08G 18/706; C08G 18/10

(57) ABSTRACT

This invention relates to a process for producing natural oil based poly-urethane dispersion, in which the hydrophobic polyol comprising the prepolymer of the dispersion is made using a natural hydroxyl oil, which is converted or modified into pure poly-diols by selective capping or blocking at temperatures of less than 100° C., without using the process of esterification or alcoholysis for deriving such polyol. The resultant dispersion is substantially free of volatile organic chemicals and/or leachable contaminants, and is naturally biodegradable.

### FIELD OF THE INVENTION

This invention relates to a process for producing natural oil based poly-urethane dispersion, in which the hydrophobic polyol comprising the prepolymer of the dispersion is made using a natural hydroxyl oil, which is converted or modified into pure poly-diols by selective capping or blocking at temperatures of less than 100° C., without using the process of esterification or alcoholysis for deriving such polyol. The resultant dispersion is substantially free of volatile organic chemicals and/or leachable contaminants, and is naturally biodegradable. On account of the superior properties/characteristics of this natural oil based poly-urethane dispersion, the same is capable of wide industrial application.

### BACKGROUND OF THE INVENTION

It is generally known that water-based anionic polyurethane-urea polymers are useful, and that the polyol is made by processes of esterification and/or alcoholysis. References describing such include the following:
1. E.P. Patent No.647665 discloses a dispersion for use as a coating on hard surfaces. In this patent, the dispersion is based on alcoholised drying oils. Further, the dispersion disclosed in this patent preferably uses an aliphatic or cyclic polyisocynate. However, this dispersion is not suitable for direct food contact applications since it is neither free of volatile and/or leachable contaminants, nor is it biodegradable and non-plastic. The composition of the dispersion disclosed in E.P. Patent No.647665 does not make it suitable in industry either.
2. U.S. Pat. No. 5,834,554 discloses a dispersion based on a sulfonated polyester based polyol, which is commonly known in prior art. However, the dispersion disclosed in U.S. Pat. No. 5,834,554 does not possess the features of being non-plastic and bio-degradable in nature. The dispersion of U.S. Pat. No. 5,834,554 is not based on an alternative polyol based on renewable feed stocks as is disclosed herein. It also does not disclose using a neutralising agent to produce the dispersion as is disclosed herein. This patent also does not use a chain extension mechanism as has been disclosed herein.
3. Similar drawbacks, as discussed with respect to U.S. Pat. No. 5,834,554, are also associated with U.S. Pat. No. 5,637,639.
4. The dispersion produced in U.S. Pat. No. 6,017,998 does not employ, amongst others, an alternative polyol based on renewable feed stocks as is disclosed herein. The dispersion so produced also lacks the characteristics of being non-plastic and bio-degradable in nature. Additionally, the dispersion disclosed in U.S. Pat. No. 6,017,998 cannot be used in direct food contact applications.
5. U.S. Pat. No. 5,037,864 discloses a semi-continuous process for preparation of a dispersion using certain containers. In this prior art, however, use of an alternative polyol based on renewable feed stocks is not disclosed. The dispersion produced in this prior art is neither free of volatile and/or leachable contaminants, nor is it biodegradable and non-plastic. The dispersion produced here is inapplicable for direct food contact applications.
6. U.S. Pat. No. 7,193,011 discloses a process of preparing a dispersion, similar to U.S. Pat. No. 5,037,864, and suffers from similar drawbacks.
7. U.S. Pat. No. 6,084,051, U.S. Pat. No. 6,642,304 and U.S. Pat. No. 6,515,070 also disclose a process of preparing a dispersion, which suffers from various drawbacks discussed above. These prior arts use reactants and reacting conditions, which make the dispersion unfit for use for direct food contact applications.
8. UK Pat. No. 1,128,568 (Farbenfabriken Bayer Aktiengesellschaft) discloses a laminating adhesive wherein anionic polyesteramide polyols are used in the preparation of water-based sulfonated/carboxylated polyurethane-urea polymers. The NCO-terminated prepolymers are processed with acetone.
9. U.S. Pat. No. 5,334,690 (Hoechst Aktiengesellschaft, Fed.) discloses a water-based sulfonated/carboxylated polyurethane-urea adhesive, wherein the anionic groups are present in the polyol segment. The solvent-less prepolymers are processed at temperatures greater than 120° C. C.
10. U.S. Pat. No. 4,851,459 and U.S. Pat. No. 4,883,694 (Century Adhesives Corp) disclose high performance water dispersible polyurethane laminating adhesives wherein the NCO-terminated prepolymers are dispersed in water and chain extended with peroxides containing hydrogen active atoms. In the preferred method of the invention, a tertiary amine is added to neutralize the anionic prepolymer.
11. U.S. Patent Application Publication No. 2008/0146748 by Blum et al. discloses the production of alkyd resin with dicarboxylic acid and drying fatty acids to arrive at its polyol. Since Blum's dispersion produces alkyd resins based dispersions, it is chemically impossible to produce such alkyd dispersions without using the process of esterification, i.e., esterification has to necessarily be used to produce the polyol of Blum. Further, given that Blum uses fatty acids, it is absolutely necessary for Blum to use metal salts or metal components to cure it as it is again chemically impossible to cure fatty acids without such components. Blum uses castor oil itself as his cross-linking agent. Since Blum's polyol is an alkyd polyol, the temperature at which the polyol is formed in Blum is more than 180° C. Further, Blum uses mono-carboxylic acid (dis-mpa) for dispersing the prepolymer in water. For the reasons, stated above, Blum's dispersion is sparingly biodegradable as opposed to being naturally biodegradable. For these reasons also the dispersion of Blum can only be used in binders and paints, which is also apparent from the field of Blum's invention

Another disadvantage associated with the prior art teachings relates to processing temperatures and polymer composition. Elevated temperatures can increase the prepolymer's crosslink density through uncontrolled isocyanate side reactions. For example, as described in the “Encyclopedia of Polymer Science and Engineering,” Vol. 13, page 252, isocyanates react with the NH group of urethanes, ureas and amides at 100° C. to 140° C. to form allophanates, biurets and acyl ureas, respectively. Polymer composition can also increase the adhesive's heat activation temperature.

To meet governmental standards, there remains a long-standing need for producing a dispersion, which is substantially biodegradable, free of volatile and/or leachable contaminants, and can be produced at reduced heat activation temperatures. The use of alcoholised drying oil has been unable to solve this problem in prior art.

There is no single solution to all the problems associated with prior art, and which can be effectively applied in industry, keeping in mind the stringent standards laid down by the government for direct food contact applications.

### AIMS AND OBJECTIVES OF THE INVENTION

The fundamental objective of this invention is to disclose a novel process for producing natural oil based poly-urethane dispersion, in which the hydrophobic polyol comprising the prepolymer of the dispersion is made using a natural hydroxyl oil, which is converted or modified into pure poly-diols by selective capping or blocking at temperatures of less than 100° C., without using the process of esterification or alcoholysis for deriving such polyol.

Another objective of this invention is disclose a novel process for producing natural oil based poly-urethane dispersion, in which the resultant dispersion is substantially free of volatile organic chemicals and/or leachable contaminants, and is naturally biodegradable.

Another objective of this invention is disclose a novel process for producing natural oil based poly-urethane dispersion, in which the resultant dispersion, on account the superior properties/characteristics of this natural oil based poly-urethane dispersion, is capable of wide industrial application.

Yet another objective of this invention is to disclose a natural oil based poly-urethane dispersion, in which the polyol is produced at reduced temperatures.

Additional objects and advantages of the invention will become apparent to those skilled in the art.

### DESCRIPTION OF THE INVENTION

This invention discloses a novel process for producing natural oil based poly-urethane dispersion, in which the hydrophobic polyol comprising the prepolymer of the dispersion is made using a natural hydroxyl oil, which is converted or modified into pure poly-diols by selective capping or blocking at temperatures of less than 100° C., without using the process of esterification or alcoholysis for deriving such polyol.

In an alternate embodiment of this invention, the polyol component of the prepolymer is a mixture of the hydrophobic polyol stated above and conventional polyols.

The capping or blocking of the polyol as disclosed in this invention can be permanent or de-blocking or pro-reactive based on the blocking or capping agent used, which is dictated by the use of the polyol. There are some blocking agents, which de-block at certain temperature to free the “—NCO” for further cross-linking or extension and resultantly cause thermo-setting. Some blocking agents cause permanent blocking, which do not break at working temperature and hence the prepolymer remains thermoplastic, as per requirement. Other blocking agents cause the resultant blocking to be Pro-reactive at ambient temperature such that the polymer is not thermo breakable, and hence is capable of cure at ambient temperature through oxidation and/or epoxidation. Such pro-reactive blocking is useful for heat sensitive substrates.

In another preferred embodiment of the invention, the polyol component of the prepolymer constitutes from 10% to 30% by weight of the total weight of the prepolymer.

The polyisocyante component used in the preparation of the water dispersible NCO-terminated polyurethane prepolymer is a diisocynate component such as aromatic isocynates or aliphatic isocynates. The molar ratio of the polyisocyanate component to the polyol component can be 2.2:1 to 1:1, and is most preferably 2:1 to 1.3:1.

Although, the presence of a solvent for the prepolymer or the polyurethane-urea is not necessary to provide a stable dispersion, the prepolymer may be optionally prepared in the presence of solvent, provided that the solvent is substantially non-reactive in the context of the isocyanate-polyol reaction. The solvents are preferably non-ionic polymeric emulsion stabilizer/wetting agents.

The amount of solvent employed should be sufficient to provide a prepolymer solution, which has a sufficiently low viscosity to enhance the formation of the polyurethane-urea dispersion of this invention. However, the solutions may be successfully employed in forming the dispersion of this invention, even though the viscosity of the solution is relatively high at the temperature of dispersion. Often about 0.01 to 10 parts by weight of solvent per part by weight of the prepolymer can be used.

Optionally, when solvent is employed during the preparation of the isocyanate-terminated prepolymer and/or the polyurethane-urea, it is desirable to remove atleast a portion of the solvent from the dispersion. Advantageously, the solvent, which is to be removed from the dispersion, has a lower boiling point than water. Thus the solvent can be removed from the dispersion by, for example, distillation. The removal of the low boiling solvent is desirably conducted under conditions which are not deleterious to the polyurethane-urea such as by vacuum distillation or thin film evaporation. A solvent, having a higher boiling point than water, such as dimethyl formamide, N-methyl-2-pyrrolidinone, and the like, may be employed. In such a case, the higher boiling solvent is generally retained in the polyurethane-urea dispersion polymer to enhance the coalescence of the polyurethane-urea particles.

Optionally, the tertiary amines are especially advantageous since the salts formed from these amines are capable of decomposing under ambient conditions with volatilization of the tertiary amine. Another advantage of these tertiary amines is that they do not take part in the isocyanate-polyol reaction. For example, when isocyanate-terminated prepolymers containing potential anionic groups are formed, it would be difficult to neutralize these groups prior to dispersion in water with primary or secondary amines due to the fact that these amines may react with the free isocyanate groups of the prepolymer. In this context, these primary or secondary amines act more like chain terminators or chain extenders than neutralizing agents, and make the subsequent high molecular weight build-up during the aqueous chain extension step more difficult and less predictable. Thus, if primary and secondary amines are used, they should preferably be used only as neutralizing agents prior to the formation of the prepolymer, i.e., when the potential anionic groups are converted to anionic groups prior to their incorporation into the prepolymer. However, the tertiary amines are preferred even when neutralization is conducted in this manner.

Optionally, when the potential anionic groups of the prepolymer are neutralized, they provide hydrophilicity to the prepolymer and better enable it to be stably dispersed in water. The potential, or unneutralized, anionic groups do not provide this degree of hydrophilicity. Accordingly, a sufficient amount of the potential ionic groups must be neutralized so that when combined with the optional hydrophilic ethylene oxide units, the polyurethane-urea final product will be a stable dispersion.

Optionally, at least about 75%, preferably atleast about 90%, of the potential anionic groups are neutralized to the corresponding anionic groups. Larger amounts of potential ionic groups may remain unneutralized. However, there are no advantages to be gained from large quantities of unneutralized potential anionic groups and their presence could be detrimental as they would minimize the improvements in hydrolytic stability, which is obtained in accordance with this invention. When smaller amounts of potential ionic groups are incorporated, it may be necessary to neutralize substantially all of these groups to obtain the desired amount of hydrophilicity. No firm guidelines can be given as to the amount of anionic groups needed, since the dispersibility of the polyurethane-urea depends on many factors including, but not limited to, the amount of hydrophilicity required, the desired particle size and the application requirements.

Optionally, therefore, the neutralization steps may be conducted:
1. prior to prepolymer formation by treating the component containing the potential ionic groups(s);
2. after prepolymer formation, but prior to dispersing the prepolymer; or
3. by adding the neutralizing agent to all or a portion of the dispersing water. The reaction between the neutralizing agent and the potential anionic groups may be conducted at temperatures below about 90° C., preferably between about 30° and 80° C., with agitation of the reaction mixture.

Once the NCO-terminated prepolymer has been formed, it is dispersed in water. The water temperature before dispersing is in a range from about 5° C. to about 90° C., and preferably from about 25° C. to about 85° C.

The dispersed NCO-terminated prepolymer is then chain extended with a polyamine. The polyamine component is a polyamine or a mixture of polyamines having an (average) amine functionality of 2 to 3 and an (average) molecular weight of from 50 to about 2000, preferably 50 to about 300. The presence of primary and/or secondary amino groups in the polyamines mentioned is crucial.

Suitable polyamines include ethylenediamine, 1,2- and 1,3-diaminopropane, 1,4-diaminobutane, 1,6-diaminohexane, isophoronediamine, isomer mixture of 2,2,4- and 2,4,4-trimethylhexa-methylenediamine, 2-methyl-pentamethylenediamine, diethylene-triamine, 1,3- and 1,4-xylylenediamine, α, α, α′, α′-tetramethyl-1,3- and -1,4-xylylenediamine and 4,4-diaminodicyclohexylmethane. Suitable diamines in the context of the invention are also hydrazine, hydrazine hydrate and substituted hydrazines, such as, for example, N-methylhydrazine, N,N′-dimethylhydrazine and their homologues and acid dihydrazides, adipic acid, β-methyladipic acid, sebacic acid, hydracrylic acid and terephthalic acid, semicarbazidoalkylene hydrazides, such as, for example, β-semicarbazidopropionic acid hydrazide (e.g. DE-A 17 70 591), semicarbazidoalkylene-carbazine esters, such as, for example, 2-semicarbazidoethylcarbazine ester (e.g. DE-A 19 18 504), or aminosemicarbazide compounds, such as, for example, β-aminoethyl semicarbazido-carbonate (e.g. DE-A 19 02 931).

In addition to these low molecular weight polyamines having a molecular weight of up to 300, it is also possible, in principle, to use polyamines of relatively high molecular weight, so that the polyamine component has an average molecular weight of up to 2000. Suitable relatively high molecular weight polyamines of this type include the known polyether polyamines obtained by conversion of the hydroxyl groups of above-mentioned polyether polyols into primary amino groups.

The particle size (mean diameter) of the fully reacted prepolymer are in a range of about 30 nanometer to about 500 nanometer, and preferably from about 40 nm to about 100 nm. The dispersions of this invention have solids content in a range from about 20% by weight to about 45% by weight, and preferably from about 30% by weight to about 40% by weight.

The natural oil based poly-urethane dispersion disclosed above is efficient in terms of cost as well as the materials used.

The natural oil based poly-urethane dispersion disclosed above is substantially free of volatile organic chemicals, leachable tertiary amine catalysts and unreacted organic amine chain terminator compounds. The natural oil based poly-urethane dispersion disclosed above is naturally biodegradable, i.e., it is biodegradable at in accordance with its environment. On account of its superior properties/characteristics, the natural oil based poly-urethane dispersion disclosed above is widely applicable in industry in a variety of ways, especially for direct food contact applications.

The natural oil based poly-urethane dispersion, produced by the process disclosed above, has good adhesion characteristics on substrates including paper, polyethylene, polypropylene, polyester, nylon, ethylene vinyl acetate, cellophane, polyvinyl chloride, non-woven films and metalized films.

The natural oil based poly-urethane dispersion produced by the process disclosed above can, therefore, be used as a laminating adhesive.

The natural oil based poly-urethane dispersion produced by the process disclosed above can, therefore, also be used on conventional lamination machines for preparing flexible film or other packaging laminates.

Additionally, the natural oil based poly-urethane dispersion produced by the process disclosed above can, therefore, also be used to produce a packaging material, which would possess properties of being waterproof, durable, long lasting, environment friendly, user friendly and capable of sealing heat.

Specifically, the natural oil based poly-urethane dispersion produced by the process disclosed above can be used to produce a packaging material suitable for, amongst others, direct food contact and durable-goods applications.

Due to the fundamental nature of this invention, the natural oil based poly-urethane dispersion produced by the process disclosed above can be used as packaging material for various goods, without any restriction/limitation of shape, size or nature of the goods.

All percentages, preferred amounts or measurements, ranges and endpoints thereof herein are inclusive. Numbers herein have no more precision than stated. All amounts, ratios, proportions and other measurements are by weight unless stated otherwise. All percentages refer to weight percent based on total composition according to the practice of the invention unless stated otherwise.

1. A process of producing natural oil based poly-urethane dispersion comprising the steps of:
a) forming a water dispersible NCO-terminated polyurethane prepolymer wherein said prepolymer is a reaction product of:
i) a hydrophobic polyol that is made using a natural hydroxyl oil, which is converted or modified into purely poly-diols state by selective capping or blocking of the hydroxyl groups at temperatures of within the range of not more than 100° C., without using the process of esterification or alcoholysis for deriving such polyol, and optionally containing other conventional polyols; and
ii) a stoichiometric excess of a diisocynate component such as aromatic isocynates or aliphatic isocynates;
b) dispersing the prepolymer in water using non-ionic polymeric emulsion stabilizer/wetting agents; and
c) reacting the prepolymer with a chain extender.

2. The process of producing natural oil based poly-urethane dispersion, as claimed in claim 1, wherein the capping or blocking of the polyol can be permanent or de-blocking or pro-reactive, based on the blocking or capping agent used.

3. The process of producing natural oil based poly-urethane dispersion, as claimed in claim 1, wherein the polyol component of the prepolymer constitutes from 10% to 30% by weight of the total weight of the prepolymer.

4. The process of producing natural oil based poly-urethane dispersion, as claimed in claim 1, wherein the molar ratio of the polyisocyanate component to the polyol component in the prepolymer is between 2.2:1 to 1:1, and most preferably between 2:1 to 1.3:1.

5. The process of producing natural oil based poly-urethane dispersion, as claimed in claim 1, such that the natural oil based poly-urethane dispersion produced is substantially free of volatile organic chemicals, leachable tertiary amine catalysts and unreacted organic amine chain terminator compounds.

6. The process of producing natural oil based poly-urethane dispersion, as claimed in claim 1, such that the natural oil based poly-urethane dispersion produced is naturally biodegradable.
